(19) United States
(12) Patent Application Publication
(10) Pub. No.: US 2018/0279086 A1
(43) Pub. Date: Sep. 27, 2018

(54) DEVICE CONTROL

(71) Applicant: McLaren Applied Technologies Limited, Woking, Surrey (GB)

(72) Inventors: Duncan James BRADLEY, Cranleigh (GB); João André Grancho SECO, London, Greater London (GB); Jay Daniel CANHAM, London, Greater London (GB)

(73) Assignee: McLaren Applied Technologies Limited, Woking, Surrey (GB)

(21) Appl. No.: 15/763,060

(22) PCT Filed: Sep. 23, 2016
(86) PCT No.: PCT/GB2016/052967

§ 371 Date: Mar. 23, 2018

(30) Foreign Application Priority Data
Sep. 25, 2015 (GB) 1516978.2

(51) Int. Cl. H04W 4/02; H04W 52/02; H04M 1/725; G06F 3/01

(52) U.S. Cl. CPC H04W 4/027; G06F 3/012; H04M 1/72569; H04W 52/0254

(57) ABSTRACT

A device for use by a user, the device comprising: a transceiver configured to communicate with at least one sensor device; and a processor communicatively coupled to the transceiver, the processor being configured to: cause the device to implement a set of predefined functions, receive user pose data and/or sensor movement data from the at least one sensor device, and modify the implementation of one or more of the predefined functions in response to at least one of the user pose data and the sensor movement data.

### CROSS-REFERENCE TO RELATED APPLICATIONS

This is a United States national phase application of PCT/GB2016/052967 filed Sep. 23, 2016 entitled “Device Control,” which claims priority from United Kingdom Application No. 1516978.2 filed Sep. 25, 2015 entitled “Device Control,” the entire disclosures of which is incorporated herein by reference.

### BACKGROUND

It is increasing common for people to possess a smartphone, or other mobile device, that can be used for a variety of functions. These devices can be carried by the user and used whilst the user is moving around. The device may also communicate with accessories carried by the user, such as (i) sensors attached to another device located on the user, perhaps in the form of a wristband that can sense movement and other data about the user; or (ii) headphones so that the device can transmit audio to the user's ears.

The functions on the device that are used by the user may change depending on the location and activity of the user. For example, when the user is on a train, the user may use the smartphone to check emails or browse websites, however when the user is walking in the street the user may play music to the headphones from the device or use a mapping function in combination with the device's satellite positioning sensor to navigate to a given location. The control of those functions may be problematic depending on the activity that the user is performing. If the device is in the user's pocket, and the user is walking, it can be difficult to interact with one of the functions that the device may be performing at that time. For instance, the user may want to switch to the next song in an album, or pause the audio. Also, the user can become distracted by operating the device in situations where the user's concentration should be focused on the environment around them. For instance, the user may be looking at the screen of the device operating the device, whilst walking along the street, when the user's concentration should be focused on traffic around them.

Various control mechanisms are in use to control a device which can be used to help solve the problems associated with controlling the device whilst the user is active. For instance, the user's voice can be used to control the device, or buttons can be provided on an accessory, such as the headphones. However, these control mechanisms may still not provide an acceptable level of control depending on the user's activity. For instance, initiating voice control generally requires direct user interaction with the device and may not be suitable in noisy environments or whilst the user is unable to speak clearly. The user may also find it difficult to use the buttons because the size of the device that they are present on is small or the way they function means that they are not easily used in all situations.

It is therefore desirable for there to be improved ways for a user to interact with a device.

### BRIEF SUMMARY

According to a first aspect of the present invention there is provided a device for use by a user, the device comprising: a transceiver configured to communicate with at least one sensor device; and a processor communicatively coupled to the transceiver, the processor being configured to: cause the device to implement a set of predefined functions, receive user pose data and/or sensor movement data from the at least one sensor device, and modify the implementation of one or more of the predefined functions in response to at least one of the user pose data and the sensor movement data.

The transceiver may be configured to communicate wirelessly with at least one sensor device. The transceiver may be configured to communicate with at least one sensor device using a wired communication link.

The processor may be configured to receive positioning data that indicates that the device is travelling at a speed greater than running pace, and modify the implementation of one or more of the predefined functions in response to the user pose data indicating that the user is sitting or standing. The device may comprise a satellite positioning sensor, communicatively coupled to the processor, for receiving positioning data. One predefined function may be a power saving mode and the processor may be configured to enable the power saving mode in response to the user pose data indicating that the user is sitting or standing.

The device may comprise a user interface, wherein one predefined function may be the configuration of the user interface, and the processor may be configured to alter the configuration of the user interface in response to the current user pose indicated by the user pose data. The current user pose may be walking or running and the configuration of the user interface may be altered to increase the size of user interface elements. The device may comprise a display and the processor is configured to display user interface on the display.

The sensor device may be a headset for wearing on the head of the user, and processor may be configured to cause the device to enter a locked state in response to the sensor movement data indicating that the headset has been removed from the user's head.

The sensor device may be comprised in an earpiece for attaching to an ear of the user, and the processor may be configured to modify the implementation of one or more predefined functions in response to the sensor movement data indicating that the user has tapped the sensor device. One predefined function may be the transmission of audio to the earpiece by the device, and the processor may be configured to adjust the volume of the audio being transmitted to the earpiece in response to the sensor movement data being indicative of a user tapping the sensor device. The transceiver may be configured to communicate with at least a first sensor comprised in a first ear piece and a second sensor comprised in a second ear piece, and the processor may be configured to receive first sensor movement data from the first sensor and second sensor movement data from the second sensor, increase the volume of the audio in response to the first sensor movement data being indicative of a user tapping the first sensor device and decrease the volume of the audio in response to the first sensor movement data being indicative of a user tapping the first sensor device. One predefined function may be accepting an incoming telephone call and the processor may be configured to cause the device to accept the incoming telephone call in response to the sensor movement data indicating that the user has tapped the sensor device.

The sensor device may be comprised in an earpiece for attaching to an ear of the user, and the processor may be configured to modify the implementation of one or more predefined functions in response to the sensor movement data being indicative of the sensor device having been moved from a normal position to a position in front of the user. One predefined function may be an audio recording function, and the processor may be configured to initiate the audio recording function in response to the sensor movement data being indicative of the sensor device having been moved from a normal position to a position in front of the user. The earpiece may comprise a microphone, and the processor may be configured to initiate audio recording from the earpiece microphone. The device may comprise a microphone, and the processor may be configured to initiate audio recording from the device microphone.

The sensor device may be comprised in an earpiece for attaching to an ear of the user, one predefined function may be the transmission of audio to the earpiece and the processor may be configured to pause the transmission of the audio in response to the sensor movement data being indicative of the sensor device having been moved from a normal position.

The sensor device may be comprised in an earpiece for attaching to an ear of the user, one predefined function may be the transmission of audio to the earpiece and the processor may be configured to transmit the audio in response to the sensor movement data being indicative of the sensor device having been moved to a normal position. The transceiver may be configured to communicate with at least a first sensor comprised in a first earpiece and a second sensor comprised in a second earpiece, one predefined function may be the transmission of audio to the earpieces and the processor may be configured to receive first sensor movement data from the first sensor and second sensor movement data from the second sensor, and pause the transmission of the audio in response to both the first sensor movement data and second sensor movement data being indicative of the sensor devices having been moved from the normal position.

The transceiver may be configured to communicate with at least a first sensor comprised in a first earpiece and a second sensor comprised in a second earpiece, one predefined function may be the transmission of audio to the earpieces and the processor may be configured to receive first sensor movement data from the first sensor and second sensor movement data from the second sensor, and transmit the audio in response to both the first sensor movement data and second sensor movement data being indicative of the sensor devices having been moved to the normal position.

The transceiver may be configured to communicate with at least a first sensor comprised in a first earpiece and a second sensor comprised in a second earpiece, one predefined function may be the transmission of audio to the earpieces and the processor may be configured to receive first sensor movement data from the first sensor and second sensor movement data from the second sensor, and adjust the volume of the audio being transmitted to the first ear piece in response to the second sensor movement data being indicative of the second sensor device having been moved from a normal position.

The transceiver may be configured to communicate with at least a first sensor comprised in a first earpiece and a second sensor comprised in a second earpiece, one predefined function may be the transmission of audio comprising two channels to the earpieces and the processor may be configured to receive first sensor movement data from the first sensor and second sensor movement data from the second sensor, and transmit both channels of audio to the first ear piece in response to the second sensor movement data being indicative of the second sensor device having been moved from a normal position. The normal position may be beside the user's ear.

The processor may be configured to modify the implementation of one or more of a set of predefined functions in response to at least one of the user pose data and/or the sensor movement data being indicative of a user moving their head relative to an initial position. The at least one of the user pose data and/or the sensor movement data may be indicative of a user changing the attitude of their head. One predefined function may be the device accepting an incoming telephone call, and the processor may be configured to accept the incoming telephone call in response to at least one of the user pose data and/or the sensor movement data being indicative of a user rotating their head downwards from an initial position and back to approximately the initial position. One predefined function may be the device accepting an incoming telephone call, and the processor may be configured to decline to accept the incoming telephone call in response to at least one of the user pose data and/or the sensor movement data being indicative of a user rotating their head left and/or right from an initial position and then back to approximately the initial position. The sensor device may be comprised in an earpiece for attaching to an ear of the user, one predefined function may be the transmission of audio to the earpiece, and the processor may be configured to pause the transmission of the audio in response to at least one of the user pose data and/or the sensor movement data being indicative of a user moving and/or rotating their head away from an initial position. The sensor device may be comprised in an earpiece for attaching to an ear of the user, one predefined function may be the transmission of audio to the earpiece, and the processor may be configured to transmit audio to the earpiece in response to at least one of the user pose data and/or the sensor movement data being indicative of a user moving and/or rotating their head back to an initial position. One predefined function may be the transmission of audio comprising two channels to a pair of earpieces, and the processor may be configured to adjust the balance of the two channels of audio being transmitted to each of the pair of earpieces in response to at least one of the user pose data and/or the sensor movement data being indicative of a user moving and/or rotating their head relative to an initial position.

The processor may be configured to receive positioning data that indicates the position of the device, one predefined function may be that the mobile device is configured to display mapping information of the locality surrounding the position of the mobile device and the processor may be further configured to change the mapping information that is displayed in response to at least one of the user pose data and/or the sensor movement data being indicative of a user moving and/or rotating their head.

One predefined function may be the transmission of audio to an earpiece, and the processor may be configured to adjust characteristics of the transmission of the audio to the earpiece in response to the user pose data indicating a change in the pose of the user. One predefined function may be the transmission of audio to an earpiece, and the processor may be configured to adjust characteristics of the transmission of the audio to the earpiece in response to the user pose data indicating that the pose of the user is a particular pose. The characteristics of the transmission of the audio may comprise the volume and/or the frequency content of the audio. The user pose data may indicate the pose of the user as running and the processor may be configured to adjust the frequency content of the audio so that the low frequencies are amplified. One predefined function may be the recording of audio, and the processor may be configured to cause the recorded audio to be transmitted by the earpiece in response to the user pose data indicating that the pose of the user is one of: walking, running, and cycling. The device may comprise a microphone for recording audio. The earpiece may comprise a microphone for recording audio.

The processor may be configured to cause the device to enter a locked state in response to the user pose data indicating that the pose of the user is a moving pose. The processor may be configured to cause the device to enter the locked state in response to the user pose data indicating that the pose of the user is one of: walking, running, and cycling. The processing may be configured to cause the device to enter the locked state after a predefined time period starting with the user pose data indicating that the pose of the user has transitioned to a moving pose.

### BRIEF DESCRIPTION OF THE FIGURES

The present invention will now be described by way of example with reference to the accompanying drawings. In the drawings:

FIG. 1 shows a schematic diagram of a device and accompanying sensor devices.

### DETAILED DESCRIPTION

The following description is presented to enable any person skilled in the art to make and use the invention, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

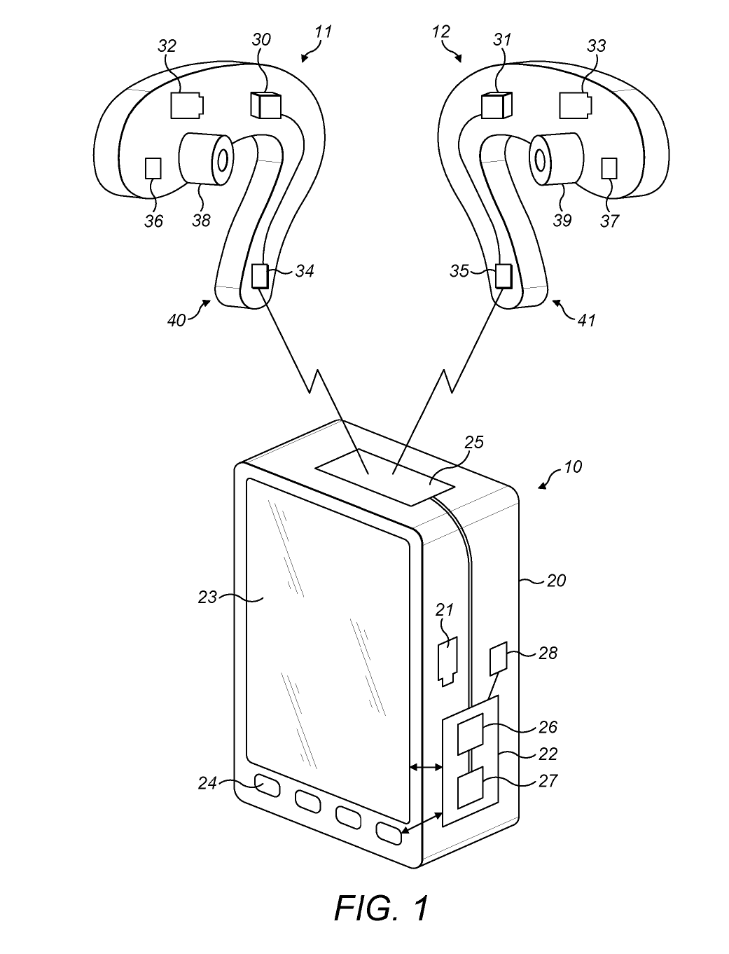

FIG. 1 shows an example device that can be controlled in dependence on the movement of one or more other devices that are connected to the example device. The example device may be a mobile device 10. The mobile device may be connected to one or more sensor devices 11, 12. In FIG. 1, two sensor devices are shown but it will be appreciated that only one or more than two may be present and in the following description reference to one sensor device may equally be applied to multiple sensor devices. The mobile device may be configured to implement a set of predefined functions. These functions may be initiated, selected and/or interacted with, or otherwise controlled, by a user. The user may use a user interface present on the device to control those functions. The mobile device is configured to receive user pose data and/or sensor movement data from the one or more sensor devices 11, 12. The mobile device is configured to modify the implementation of one or more of the set of predefined functions in response to at least one of the user pose data and sensor movement data. For instance, the sensor movement data may be indicative of the user removing the sensor devices from their ears and so the mobile device may pause the streaming of audio data to the sensor devices.

The mobile device 10 of FIG. 1 comprises a housing 20. Within the housing are a battery 21, a processing section 22 and a memory 28. The mobile device 10 also comprises a user interface constituted by a display 23 and a series of user-actuable switches 24 which are exposed on the exterior of the housing. The display and switches could be combined into a touchscreen device. The mobile device 10 comprises a first wireless communication device 25 for communicating with the sensor devices 11, 12. The mobile device 10 may use the first wireless communication device 25 to also communicate with other devices. The wireless communication devices may be known as transceivers.

The battery 21 stores energy for powering the other components.

The mobile device 10 may be capable of performing a plurality of functions. These functions may be implemented and controlled by the processing section 22. The processing section could perform its functions using dedicated hardware, using a general purpose processor executing software code, or using a combination of the two. A processor 26 executes software code stored in a non-transient way in software memory 27 in order to perform its functions. The processing section 22 can read/write data from/to memory 28.

The mobile device 10 could include other interfaces and sensors. For example, it could include any one or more of:

a satellite positioning sensor which could provide information on the location and/or altitude of the mobile device 10 to the processing section 22;

a wired or wireless communication interface for allowing communication between the processing section 22 and a remote device, for example a cellular telephony interface, a Wi-Fi (IEEE 802.11) interface, a Bluetooth interface or a USB (universal serial bus) interface;

an environmental sensor such as a temperature sensor or a humidity sensor, which could provide information on the environment around the mobile device 10 to the processing section 22;

a loudspeaker, by which alerts could be provided to a user; and

a microphone, which in combination with the loudspeaker could permit the mobile device 10 to function as a telephone.

It will be appreciated that, although the device 10 is described as a mobile device in many of the examples given herein, the device 10 could also be a device that is not easily portable by the user, such as a desktop computer.

In FIG. 1, the sensor devices 11, 12 are each in the form of an earpiece. The sensor devices 11, 12 may each comprise accelerometers 30, 31, a local battery 32, 33, and a wireless communication device 34, 35 for communicating with the first wireless communication device 25 of the mobile device 10. Alternatively, only one sensor device 11 may be present, or first sensor device 11 may use second wireless communication device 34 to communicate with the first wireless communication device 25 of the mobile device, and the second sensor device 12 may communicate with the first sensor device 11. The first sensor device 11 may communicate with the mobile device 10 on behalf of second sensor device 12. First sensor device 11 and second sensor device 12 may be connected together by wire rather than by wireless connection. The sensor devices may communicate with the mobile device 10 by a wired connection rather than by wireless connection. The sensor devices 11, 12 could include other sensors. For example, the sensor devices 11, 12 could include gyroscopic sensors, for example one or more rate gyro sensors.

Collectively, the accelerometers 30, 31 are preferably capable of sensing acceleration in any direction. To that end the accelerometers could be provided by set of three integrated or discrete accelerometers arranged to sense acceleration along respective orthogonal axes. Alternatively, the accelerometers could be arranged to sense acceleration along one or more specific axes that are orientated in a predetermined fashion with respect to the user's body: for example there could be only a single accelerometer, which could be arranged with respect to the user's body so as to sense acceleration in a vertical or substantially vertical direction when the user is walking or running; or there could be only two accelerometers, which could be arranged with respect to the user's body so as to sense acceleration in a vertical or substantially vertical direction and in a lateral or substantially lateral direction when the user is walking or running. In a preferred example the accelerometers provide a time series of acceleration values. The accelerometers could be mechanical accelerometers. Preferably the accelerometers measure acceleration directly.

The earpieces 11 and 12 can also each include a loudspeaker 36, 37. The processing unit 22 of the mobile device 10 may be capable of replaying audio from data stored in the memory 28 to the loudspeaker(s) 36, 37 via a wireless communication link between transceivers 25 and 34, 35. Alternatively the earpiece itself may be capable of replaying audio through the loudspeaker, using an audio processor integrated in the earpiece. The mobile device 10 may transfer an audio file stored in memory 28 to the earpiece for processing by the audio processor integrated in the earpiece.

The ear piece may attach to the user's ear by a formation 40, 41 of its housing that wraps around the ear of a wearer and/or by virtue of an ear bud 38, 39 that can be inserted into and lodge in the ear canal of the wearer. These mechanisms allow the earpiece 11, 12 to be attached firmly to the user's head, so that they move with the user's head. This allows the accelerometers 30, 31 in the earpiece to gather accurate data about the motion of the user's head. It has been found that mounting the accelerometers in an earpiece is a particularly convenient approach since it provides good data about the user's gait and because many users find an earpiece to be a convenient form in which to carry a device attached firmly to their body. Furthermore, when the earpiece can also replay audio, for example, music, to a user, the user can enjoy that audio whilst exercising.

The sensor devices 11, 12 can each transmit sensed data using their respective wireless communication devices 34, 35 to the first wireless communication device 25 of the mobile device 10. The sensor device 11, 12 may be capable of processing the outputs of the accelerometers 30, 31 and, if present, gyroscopic sensors 30, 31. The sensor device 11, 12 may incorporate processing sections that are similar in function to the processing section 22 of mobile device 10. The processing sections in sensor devices 11, 12 may have a lower processing capability to reduce power consumption. The processing section of the sensors may undertake the processing of the outputs of the accelerometers 30, 31 and, if present gyroscopic sensors 30, 31 to detect elements of interest in the live acceleration being sensed from the motion of a user. The current pose of the user may be detected from the live acceleration data. An example set of methods and equipment of processing acceleration data and, if present, gyroscopic data to determine the current pose of the user is described in co-pending UK patent application no. GB1422847.2. Where permitted, GB1422847.2 is herein incorporated by reference. These methods and equipment involve the sensing of accelerations at a series of moments over time a time-series of accelerations is produced. Accelerations sensed most recently (e.g. during a window extending back between 1 and 10 seconds from the latest sensed acceleration) can be compared with one or both of: (i) specific acceleration features derived from the analysis of previously logged data for the same and/or other users and identified as correlating with certain gait artefacts; and (ii) comparisons between assessments of the recently sensed accelerations according to one or more metrics and predetermined thresholds for those assessments.

The live acceleration data may also be processed to generalise the acceleration of the sensor to reduce the data rate of the acceleration data. The live acceleration data may be processed to produce time-series acceleration data with a greater time between each acceleration data value. The acceleration data may form part of the sensor motion data that is derived by the sensor. The orientation data provided by the gyroscopic sensor may also be processed to derive sensor motion data. The user pose data and/or the sensor motion data can be transmitted by the sensor to the mobile device 10. The user pose data and/or sensor motion data may be transmitted continuously, periodically or when a change in the data is detected. For instance, the sensor device may detect that there has been a change in the user's pose and send an update to the user pose data at that point.

The user pose data may indicate the user's current pose is one of the following:
sitting;
standing;
walking;
running;
lying down;
sleeping;
cycling; and/or
swimming.

The sensor device may be capable of detecting that the user's current pose is one of a subset of those poses listed above.

The user pose data may also indicate the attitude of a user's head, or changes thereof. The sensor device may keep an estimate of the current position of the user's head and update that estimate when acceleration is sensed. The sensor device can then provide the mobile device with user pose data that indicates the current attitude of their head about either or both axes.

The operation of the mobile device 10 in dependence on the user pose data and/or sensor movement data will now be described using a number of examples. It will be appreciated that these examples may be generalised and/or may be used in any combination with each other.

### Mode of Transport Detection

The mobile device may receive user pose data, from one or more sensor devices, that indicates that the user is sitting or standing. The mobile device may comprise a satellite positioning sensor and/or receive positioning data that indicates that the mobile device is travelling at a speed greater than normal running pace. Based on the specific user pose data and positioning data, the mobile device may detect that the user is travelling in a vehicle and modify the implementation of at least one predefined function of the mobile device. One predefined function may be a power saving mode of the mobile device and the mobile device may be configured to enable the power saving mode whilst the mobile device has detected that the user is travelling in a vehicle.

### Device User Interface Management

The mobile device may receive user pose data, from one or more sensor devices, that indicate the current pose of the user. The mobile device may modify the implementation of at least one predefined function of the mobile device based on the current pose of the user. The mobile device 10 may display a user interface on the display 23, the display 23 may be a touchscreen. The mobile device 10 may also use user-actuable switches 24 to permit user interaction with the device. One predefined function may be the configuration of the user interface on the display and the mobile device may be configured to alter the configuration of the user interface based on the current pose of the user. For example, if the current pose of the user indicates that the user is running then the size of the buttons displayed on the user interface may be increase so that the user can easily press those buttons whilst running. If the current pose of the user indicates that the user is sitting then the buttons displayed on the user interface may give access to predefined functions such as an email client and/or calendar.

### Headset Locking/Unlocking

The mobile device 10 may receive sensor movement data, from one or more sensor devices, that indicates the movement of the sensors. The mobile device 10 may receive sensor movement data from a sensor device that comprises one accelerometer. The sensor device may have only one sensor in the form of an accelerometer.

The one or more sensor devices may be a headset and/or earpiece. As discussed above the sensor devices may include a loudspeaker. The sensor movement data may be indicative of the headset being removed from the user's head. One predefined function may be whether the user interface of the mobile device is in a locked or unlocked state. In a locked state, a reduced set of predefined functions, relative to the unlocked state, may be available for use on the user interface of the mobile device. The mobile device may be configured to enter the locked state when the sensor movement data is indicative of the headset being removed from the user's head. The mobile device may compare the sensor movement data to a pre-recorded set of sensor movement data to determine that the sensor movement data indicates that the headset has been removed.

### Sensor Device Touch Control of Mobile Device

The mobile device 10 may receive sensor movement data, from one or more sensor devices, that indicates the movement of the sensors. The mobile device 10 may receive sensor movement data from a sensor device that comprises one accelerometer. The sensor device may have only one sensor in the form of an accelerometer.

The one or more sensor devices may each be in the form of an earpiece. As discussed above the sensor devices may include a loudspeaker. The sensor movement data may be indicative of the sensor device having been tapped by the user. The mobile device may be configured to modify the implementation of one or more of a set of predefined functions in response to the sensor movement data being indicative of a user tapping the sensor device.

One predefined function may be the transmission of audio to the earpiece. The device may be configured to adjust the volume of the audio being transmitted to the earpiece in response to the sensor movement data being indicative of a user tapping the sensor device. The mobile device may increase the volume. The mobile device may decrease the volume. The audio may be audio from a media player application running on the mobile device. The audio may be from a telephone call being received by the mobile device.

The mobile device may receive first sensor movement data from a first sensor located in a first ear piece and second sensor movement data from a second sensor located in a second ear piece. The mobile device may be configured to increase the volume of the audio in response to the first sensor movement data being indicative of a user tapping the first sensor device. The mobile device may be configured to decrease the volume of the audio in response to the first sensor movement data being indicative of a user tapping the first sensor device.

Another predefined function may be the mobile device accepting an incoming telephone call. The mobile device may be configured to accept the incoming telephone call in response to the sensor movement data being indicative of a user tapping the sensor device.

### User Movement Control of Mobile Device

The mobile device may receive user pose data, from one or more sensor devices, that indicates the attitude of a user's head, or changes thereof. The mobile device may be configured to derive, from at least one of the user pose data and sensor movement data, the movement of a user's head relative to an initial position. The mobile device 10 may receive user pose data and/or sensor movement data from one or more sensor devices that comprise: an accelerometer, and/or a gyroscopic sensor.

The mobile device may be configured to modify the implementation of one or more of a set of predefined functions in response to at least one of the user pose data and/or the sensor movement data being indicative of a user moving their head relative to an initial position. The mobile device may be configured to modify the implementation of one or more of a set of predefined functions in response to at least one of the user pose data and/or the sensor movement data being indicative of a user changing the attitude of their head.

One predefined function may be the mobile device accepting an incoming telephone call. The mobile device may be configured to accept the incoming telephone call in response to at least one of the user pose data and/or the sensor movement data being indicative of a user rotating their head downwards from an initial position and then back to approximately the initial position. The user pose data and/or the sensor movement data may be indicative of a user nodding their head.

One predefined function may be the mobile device declining to accept an incoming telephone call. The mobile device may be configured to decline to accept the incoming telephone call in response to at least one of the user pose data and/or the sensor movement data being indicative of a user rotating their head left and/or right from an initial position and then back to approximately the initial position. The user pose data and/or the sensor movement data may be indicative of a user shaking their head.

One predefined function may be the transmission of audio to the earpiece. The device may be configured to pause the transmission of the audio being transmitted to the earpiece in response to at least one of the user pose data and/or the sensor movement data being indicative of a user moving and/or rotating their head away from an initial position. The user pose data and/or the sensor movement data may be indicative of a user looking away from the mobile device.

One predefined function may be the transmission of audio to the earpiece. The device may be configured to initiate or resume the transmission of the audio being transmitted to the earpiece in response to at least one of the user pose data and/or the sensor movement data being indicative of a user moving and/or rotating their head back to an initial position. The user pose data and/or the sensor movement data may be indicative of a user looking towards the mobile device.

One predefined function may be the transmission of audio to a pair of earpieces. The audio may comprise two channels of audio. The audio may be stereo. The device may be configured to adjust the balance of the two channels of audio being transmitted to each of the pair of earpieces in response to at least one of the user pose data and/or the sensor movement data being indicative of a user moving and/or rotating their head relative to an initial position. The device may adjust the volume of each of the two channels of audio that are being transmitted to an earpiece.

The mobile device may comprise a satellite positioning sensor and/or receive positioning data that indicates the position of the mobile device. One predefined function may be that the mobile device is configured to display mapping information of the locality surrounding the position of the mobile device. The device may be configured to change the mapping information that is displayed in response to at least one of the user pose data and/or the sensor movement data being indicative of a user moving and/or rotating their head.

### Sensor Movement Control of Mobile Device

The mobile device 10 may receive sensor movement data, from one or more sensor devices, that indicates the movement of the sensors. The mobile device 10 may receive sensor movement data from a sensor device that comprises one accelerometer. The sensor device may have only one sensor in the form of an accelerometer. The mobile device may receive sensor movement data from one or more sensor devices that comprise: one accelerometer, two accelerometers, more than two accelerometers. The sensor device may comprise a microphone.

The one or more sensor devices may each be in the form of an earpiece. As discussed above the sensor devices may include a loudspeaker. The sensor movement data may be indicative of the sensor device having been moved from a normal position for an ear piece. The normal position may be the position associated with an ear piece being attached to a user's ear. The normal position may be derived from the ear piece being located in a particular position for a predefined length of time. The normal position may be calibrated by the user indicating to the mobile device that the ear piece is in the normal position.

The sensor movement data may be indicative of the sensor device having been moved from a normal position to a position in front of the user. One predefined function may be an audio recording function. The mobile device may be configured to initiate the audio recording function in response to the sensor movement data may be indicative of the sensor device having been moved from a normal position to a position in front of the user. The earpiece may comprise a microphone for the recording of audio and the mobile device may initiate recording of audio from the microphone of the earpiece.

The sensor movement data may be indicative of the sensor device having been moved from a normal position. The sensor movement data may be indicative of the sensor device having been removed from a user's ear. One predefined function may be the transmission of audio to the earpiece. The device may be configured to pause the transmission of the audio in response to the sensor movement data being indicative of the sensor device having been moved from a normal position. The device may comprise a loudspeaker and be configured to transmit the audio using the loudspeaker instead of transmitting the audio to the earpiece in response to the sensor movement data being indicative of the sensor device having been moved from a normal position.

The sensor movement data may be indicative of the sensor device having been moved to a normal position. The sensor movement data may be indicative of the sensor device having been placed in a user's ear. One predefined function may be the transmission of audio to the earpiece. The device may be configured to initiate or resume the transmission of the audio in response to the sensor movement data being indicative of the sensor device having been moved to a normal position.

The mobile device may receive first sensor movement data from a first sensor located in a first ear piece and second sensor movement data from a second sensor located in a second ear piece. The mobile device may be configured to pause and/or initiate/resume the transmission of audio in response to both the first sensor movement data and second sensor movement data being indicative of the sensor devices having been moved from/to the normal position.

One predefined function may be the transmission of audio to a pair of earpieces. The mobile device may receive first sensor movement data from a first sensor located in a first ear piece and second sensor movement data from a second sensor located in a second ear piece. The mobile device may be configured to adjust the volume of the audio being transmitted to the first ear piece in response to the second sensor movement data being indicative of the second sensor device having been moved from a normal position. The mobile device may increase the volume of the audio being transmitted to the first ear piece. The mobile device may decrease the volume of the audio being transmitted to the first ear piece.

The audio may comprise two channels of audio. The audio may be stereo. The mobile device may be configured to transmit both channels of audio to the first ear piece in response to the second sensor movement data being indicative of the second sensor device having been moved from a normal position.

The audio may be audio from a media player application running on the mobile device. The audio may be from a telephone call being received by the mobile device.

### User Pose Control of Mobile Device

The mobile device may receive user pose data, from one or more sensor devices, that indicate the current pose of a user. The one or more sensor devices may each be in the form of an ear piece. As discussed above the sensor devices may include a loudspeaker. One predefined function may be the transmission of audio to the earpiece. The mobile device may be configured to adjust characteristics of the transmission of the audio to the earpiece in response to the user pose data indicating a change in the pose of the user. The mobile device may be configured to adjust characteristics of the transmission of the audio to the earpiece in response to the user pose data indicating that the pose of the user is a particular pose. The characteristics of the transmission of the audio may be the volume and/or the frequency content of the audio.

The pose of the user may be running and the mobile device may be configured to adjust the frequency content of the audio so that the low frequencies are amplified. The mobile device may be configured to emphasise the beat of the audio.

The mobile device may comprise a microphone for recording audio. The ear piece may comprise a microphone for recording audio. The mobile device may be configured to cause the recorded audio to be transmitted by the earpiece in response to the user pose data indicating that the pose of the user is one of: walking, running, and cycling. The mobile device may be configured to transmit the recorded audio to the earpiece in response to the user pose data indicating that the pose of the user is one of: walking, running, and cycling. The mobile device may be configured to transmit both the recorded audio and other audio to the earpiece at the same time.

As discussed above one predefined function may be whether the user interface of the mobile device is in a locked or unlocked state. In a locked state, a reduced set of predefined functions, relative to the unlocked state, may be available for use on the user interface of the mobile device. The mobile device may be configured to enter the locked state in response to the user pose data indicating that the pose of the user is one in which the user is moving, which might be one of: walking, running, and cycling. The mobile device may be configured to enter the locked state after a predefined time period starting with the user pose data indicating that the pose of the user has transitioned to one in which the user is moving.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A device for use by a user, the device comprising:
a transceiver configured to communicate with at least one sensor device; and
a processor communicatively coupled to the transceiver, the processor being configured to: cause the device to implement a set of predefined functions, receive user pose data and/or sensor movement data from the at least one sensor device, receive positioning data that indicates that the device is travelling at a speed greater than running pace, modify the implementation of one or more of the predefined functions in response to at least one of the user pose data and the sensor movement data, and modify the implementation of one or more of the predefined functions in response to the user pose data indicating that the user is sitting or standing.

2. The device according to claim 1, wherein the transceiver is configured to communicate wirelessly with at least one sensor device.

3. The device according to claim 1, wherein the transceiver is configured to communicate with at least one sensor device using a wired communication link.

4. (canceled)

5. The device according to claim 1, the device comprising a satellite positioning sensor, communicatively coupled to the processor, for receiving positioning data.

6. The device according to claim 1, wherein one predefined function is a power saving mode and the processor is configured to enable the power saving mode in response to the user pose data indicating that the user is sitting or standing.

7. The device according to claim 1, the device comprising a user interface, wherein one predefined function is the configuration of the user interface, and the processor is configured to alter the configuration of the user interface in response to the current user pose indicated by the user pose data.

8. The device according to claim 7, wherein the current user pose is walking or running and the configuration of the user interface is altered to increase the size of user interface elements.

9. The device according to claim 7, the device comprising a display and the processor is configured to display user interface on the display.

10. The device according to claim 1, wherein the sensor device is a headset for wearing on the head of the user, and processor is configured to cause the device to enter a locked state in response to the sensor movement data indicating that the headset has been removed from the user's head.

11-14. (canceled)

15. The device according to claim 1, wherein the sensor device is comprised in an earpiece for attaching to an ear of the user, and the processor is configured to modify the implementation of one or more predefined functions in response to the sensor movement data being indicative of the sensor device having been moved from a normal position to a position in front of the user.

16. The device according to claim 15, wherein one predefined function is an audio recording function, and the processor is configured to initiate the audio recording function in response to the sensor movement data being indicative of the sensor device having been moved from a normal position to a position in front of the user.

17. The device according to claim 16, wherein the earpiece comprises a microphone, and the processor is configured to initiate audio recording from the earpiece microphone.

18. The device according to claim 16, wherein the device comprises a microphone, and the processor is configured to initiate audio recording from the device microphone.

19-24. (canceled)

25. A device according to claim 15, wherein the normal position is beside the user's ear.

26-32. (canceled)

33. The device according to claim 1, wherein the processor is configured to receive positioning data that indicates the position of the device, one predefined function is that the mobile device is configured to display mapping information of the locality surrounding the position of the mobile device and the processor is further configured to change the mapping information that is displayed in response to at least one of the user pose data and/or the sensor movement data being indicative of a user moving and/or rotating their head.

34. The device according to claim 1, wherein one predefined function is the transmission of audio to an earpiece, and the processor is configured to adjust characteristics of the transmission of the audio to the earpiece in response to the user pose data indicating a change in the pose of the user; wherein the characteristics of the transmission of the audio comprise the volume and/or the frequency content of the audio; and wherein the user pose data indicates the pose of the user as running and the processor is configured to adjust the frequency content of the audio so that the low frequencies are amplified.

35. The device according to claim 1, wherein one predefined function is the transmission of audio to an earpiece, and the processor is configured to adjust characteristics of the transmission of the audio to the earpiece in response to the user pose data indicating that the pose of the user is a particular pose; wherein the characteristics of the transmission of the audio comprise the volume and/or the frequency content of the audio; and wherein the user pose data indicates the pose of the user as running and the processor is configured to adjust the frequency content of the audio so that the low frequencies are amplified.

36-40. (canceled)

41. The device according to claim 1, wherein the processor is configured to cause the device to enter a locked state in response to the user pose data indicating that the pose of the user is a moving pose.

42. The device according to claim 41, wherein the processor is configured to cause the device to enter the locked state in response to the user pose data indicating that the pose of the user is one of: walking, running, and cycling.

43. The device according to claim 41, wherein the processing is configured to cause the device to enter the locked state after a predefined time period starting with the user pose data indicating that the pose of the user has transitioned to a moving pose.

44. (canceled)
